(19) United States
(12) Patent Application Publication
(10) Pub. No.: US 2009/0004167 A1
(43) Pub. Date: Jan. 1, 2009

(54) Use of Inorganic Peroxides for Oxygenation of Soil in Order to Prevent Diseases Caused by Anaerobic Agents in Plants

(75) Inventors: Noel Boulos, Bellaire, TX (US); Marv Crumb, Sammamish, WA (US)

Correspondence Address: OBLON, SPIVAK, MCCLELLAND MAIER & NEUSTADT, P.C., 1940 DUKE STREET, ALEXANDRIA, VA, 22314, US

(73) Assignee: Solvay (Societe Annonyme), Brussels (BE)

(21) Appl. No.: 11/632,144

(22) PCT Filed: Jul. 13, 2005
(86) PCT No.: PCT/EP05/53364

§ 371 Date: Oct. 1, 2007

Related U.S. Application Data
(60) Provisional application No. 60/587,491, filed on Jul. 14, 2004.

(51) Int. Cl. A01N 59/00; A01N 63/00; A01N 61/00; A01P 1/00; A01P 3/00; A01N 59/16; A01N 59/06

(52) U.S. Cl. 424/94.1; 424/613; 424/614; 424/615

(57) ABSTRACT

A method for controlling diseases caused by anaerobic agents in plants by at least partially preventing, stopping or reversing the damage caused by the anaerobic agents, comprising treating the plant or the soil in which the plant is growing or will grow with at least one inorganic peroxide. A formulation for the control of such diseases in plants, comprising at least one inorganic peroxide and at least one additive chosen from biological agents, nutrients and their mixtures.

### CROSS-REFERENCE TO RELATED APPLICATIONS

The present application claims the benefit of U.S. application Ser. No. 60/587,491 filed on Jul. 14, 2004, herein incorporated by reference

### FIELD OF THE INVENTION

The invention relates to a method for correcting, modifying and remediating the soils containing pathogens that thrive in anaerobic environments and in the best cases a method for controlling diseases caused by anaerobic agents in plants by at least partially preventing, stopping or reversing the damage caused by the anaerobic agents by using inorganic peroxides for the oxygenation of soil, and to formulations suitable for such a treatment.

Additional advantages and other features of the present invention will be set forth in part in the description that follows and in part will become apparent to those having ordinary skill in the art upon examination of the following or may be learned from the practice of the present invention. The advantages of the present invention may be realized and obtained as particularly pointed out in the appended claims. As will be realized, the present invention is capable of other and different embodiments, and its several details are capable of modifications in various obvious respects, all without departing from the present invention. The description is to be regarded as illustrative in nature, and not as restrictive.

### BACKGROUND OF THE INVENTION

There are problems in many plants that get diseases from microbes, fungi or viruses that grow under anaerobic conditions. This is particularly the case for potatoes (scabs) and other plants that are afflicted by root rot diseases. Root rot is a disease that affects the roots of trees such as conifers, avocado and citrus, crops such as potatoes, peppers, tomatoes, strawberries and raspberries, ornamental plants such as azaleas, and turfgrass. The agent responsible for the disease is anaerobic, so it grows when the soil becomes anaerobic.

Hydrogen peroxide has been recommended to provide oxygen to the soil in order to control the development of these anaerobic organisms and prevent or reverse the course of these diseases. The international patent application WO 00/05969 discloses a method for treating soil using hydrogen peroxide.

Calcium peroxide is commonly used for seed coating in order to provide oxygen to the soil during the initial germination period and assists the plant in establishing strong roots at the beginning of the germination. For instance, the publication in Plant and Soil, vol 99, p. 357-363, 1987 is related to calcium peroxide as a seed coating material for padi rice.

The purpose of the present invention is to provide an alternative method to at least partially prevent these diseases or at least partially stop the damage caused by anaerobic organisms.

### SUMMARY OF THE INVENTION

The invention objectives of at least partially preventing diseases or stopping the damage caused by anaerobic agents in crops are accomplished by treating the plant or the soil in which the plant is growing or will grow with at least one inorganic peroxide. In addition, the plant or the soil can be treated with at least one additive chosen from biological agents, nutrients and their mixtures.

The invention is also related to a process for applying the inorganic peroxide to the plant or to the soil.

The invention is also related to a formulation for the control of diseases by at least partially preventing, stopping or reversing the damage caused by anaerobic agents in plants comprising at least one inorganic peroxide and at least one additive chosen from biological agents, enzymes, humic acid, nutrients and their mixtures.

The novel notion of the present invention is that by implementing these holistic applications, the synergistic effect will result in the correction, modification and remediation of the soil abnormalities that lead to an anaerobic environment contributing to anaerobic pathogens, such as root rot, growth and spread. By modifying the soil environment, a root rot suppressive soil environment (oxygen rich balanced nutrition) is created that encourages and stimulates the plants self-defense mechanisms against root rot, or other destructive anaerobic pathogens and insects, and leads to aggressive root growth. The anaerobic pathogens will not be totally eliminated as indeed these pathogens may remain dormant in the soils but the disease can effectively be controlled and healthy plants can grow.

### DETAILED DESCRIPTION OF THE PREFERRED EMBODIMENTS OF THE INVENTION

The addition of inorganic peroxides to the soil or the seeds provides oxygen around the roots. This improves the situation because the growth of the anaerobic agents responsible for the disease is reduced or stopped. This can apply to diseased trees, crops, ornamental plants or turf or the concept can also be extended to trees, crops, ornamental plants or turf that are not yet diseased.

The advantage of using inorganic peroxides versus hydrogen peroxide is the slow release of oxygen for the aeration of the soil.

Examples of plants which can be treated in the method of the invention include crops such as potatoes, peppers, tomatoes, strawberries, raspberries, trees such as avocado, citrus and conifers, ornamental plants such as Azaleas, and turfgrass.

The anaerobic agent to be hindered in the method of the invention can be microbes, fungi and viruses such as Phytophthora, Pythium, Black, Dry, Annosum, Armillaria, Rhizoctonia, Laminated, and Annosus root rot.

The biological agents which can be used in the method of the invention are microbes which act as antagonists to phytopathogenic species and act as beneficial agents to promote plant growth. Suitable biological agents include Mycorrhizae, Bacilli, Pseudomonas, Streptomyces, Trichoderma, Tallaromyces, Gliocladium and species of yeast. They can be chosen from the commercial product Organica's Microbial Soil Conditioner and similar products.

The disease controlled by the method of the invention is most often root rot disease. This is caused by many species of fungi. For example Phytophthora cinnamomi (phytophthora root rot) causes serious disease and plant death for avocado trees.

This fungus thrives in excess soil moisture (over-irrigation and poor drainage) and attacks trees of any size/age. Diseased trees may set a heavy crop of small fruit, but diseased trees will decline and die, either rapidly or slowly.

The inorganic peroxide used in the method of the invention can be chosen from magnesium peroxide, calcium peroxide, zinc peroxide, mixed calcium/magnesium peroxides, sodium percarbonate and their mixtures. Calcium peroxide and magnesium peroxide are preferred. Calcium peroxide is particularly preferred.

The inorganic peroxide can be used in the form of a powder, in the form of granules or in the form of a slurry, which is preferably aqueous.

According to a first realization form of the method of the invention, the inorganic peroxide and/or the additive, if used, are applied to the soil before planting.

According to a second realization form of the method of the invention, the inorganic peroxide and/or the additive, if used, are applied to the soil by injecting an aqueous slurry of the inorganic peroxide and/or the additive near the plant. Calcium peroxide can for instance be injected around a diseased tree at a dose of from 0.5 to 10 lb/tree, for instance at a dose of about 6 lb/tree.

According to a third realization form of the method of the invention, the inorganic peroxide and/or the additive, if used, are spread on the surface of the soil.

According to a fourth realization form of the method of the invention, the inorganic peroxide and/or the additive, if used, are applied through an irrigation system. The inorganic peroxide, preferably calcium peroxide, can be suspended in the irrigation water at a level which is most preferably from 0.5 to 10 lb per tree, for instance about 3 lb/tree. This can go at the front end of the irrigation, followed by irrigation with plain water for instance for the rest of the day. The additive, preferably biological agents, can be added before or after the inorganic peroxide. It is particularly advantageous to wait a few days, for instance for a week, and then apply a combination of biological agents and nutrients.

The four realization forms can be combined without any restriction by combining two or more of the four forms.

In the method of the invention, the inorganic peroxide and/or the additive can be applied only once or the treatment can be repeated as needed to maintain enough oxygen in the soil to control the diseases. The treatment with the inorganic peroxide and/or with the additive is preferably repeated several times. It may for instance be repeated at 6 (six) months intervals and/or until the effect of the disease abates and the plants return to an economically viable production.

The inorganic peroxide could be applied either in combination with the other additives or separately. If the additives are added separately, they could be added either before or after the inorganic peroxide. In general, it is preferred to apply first the inorganic peroxide and then the additive.

Additives include biological agents which are products such as the product called Spectrum Extra from Tainio Technology that contain a large combination of live beneficial soil microorganisms especially selected to enhance digestion of organic matter. Another example is the product called Biogenesis 1 from Tainio Technology which is a formulation of microorganisms and humic acids. Alternatively humic acid, oxidized lignites or extracts can be added separately, for example the products called Mesa Verde Green Humates from Tainio Technology. The additive can also be a combination of enzymes such as the product called Pepzyme M from Tainio Technology which create a better environment for root development.

It is also possible to use additional micronutrients or macronutrients which can be added to the soil before, together or after the inorganic peroxide treatment. Additional micronutrients can be chosen from products such as the commercial AZOMITE® soil sweetener that contains a broad-spectrum of mineral elements. This is to compensate for the loss of these elements due to uptake by the trees for fruit production. Macronutrients can be typical fertilizers used in the trade containing sources of N, P and K. The additional nutrients can also be added by injection or spreading on the surface or in the irrigation system. When a combination of micronutrients and biological agents is used, it is preferred to add the micronutrients at about the same time as the biological agents.

The present invention is also related to a formulation for soil remediation for the control of diseases caused by anaerobic agents in plants, comprising at least one inorganic peroxide and at least one additive chosen from biological agents, enzymes, humic acid, nutrients and their mixtures. The purpose is to achieve a balanced soil nutritional environment. The inorganic peroxide, the other additives and the nutrients are as defined above. In the formulation according to the invention, it is possible that the inorganic peroxide and the additive are not mixed so that they can be used separately.

### Example 1

On May 2004 treatment was applied to 4 mature 28-year old cv Hass and 7 young 3-years old cv Hass avocado trees.

A slurry of IXPER® 75C Calcium Peroxide commercialized by Solvay Chemicals, Inc. was injected in the root zone of each of the trees to a depth of 4-6″ via soil probe injector attached to a standard agricultural Solo backpack sprayer. On the mature medium sized trees, the slurry containing 32 oz IXPER®75C Calcium Peroxide and 2.5 gallons of water was injected at 22 sites around the drip line of each tree. On the 3-year old avocado trees a slurry containing 12 oz of IXPER®C75C Calcium Peroxide and 2.5 gallons of water was injected at 8 sites around the drip line of each tree.

Tainio Technology and Technique, Inc. Biological Farm management products were also injected in the soil at the tree drip. The biological treatment with the commercial products called Spectrum Extra, Pepzyme M and Biogenesis 1 were combined and mixed in 2.5 gallons of water and applied via a soil probe injector attached to a standard Solo backpack sprayer, at a rate prescribed for each material.
Spectrum Extra was applied at the rate of 11 g for each medium size mature tree and 4 g for each of the young 3-year old trees.
Pepzyme M was applied at the rate of 11 teaspoons for each medium tree and 4 teaspoons for the young 3-year old trees.
Biogenesis 1 was applied at the rate of 0.44 oz for each of the medium size mature trees and 0.16 oz for each of the young 3-year old trees.
Mesa Verde Humates was hand broadcasted in the root zone at a rate of 5 lb/tree for medium size mature trees and 1 lb/tree for young 3-year old trees.
AZOMITE® was hand broadcast in the root zone at a rate of 5 lb/tree for medium size mature trees and 1 lb/tree for young 3-year old trees.

The following shows the condition of the treated trees before treatment (May 2004), and 13 months after treatment (June 2005)
Mature cv Hass avocado trees 28-year old:
   In May 2004, 2 trees were showing severe decline and were marked for removal. In June 2005, spring flush was underway, leaves tended to be a little smaller than standard but not as small as what was observed at the time of treatment in May of the previous year. The Spring leaf flush was not as large as standard. The leaf size was encouraging and some of the early leaves appeared to have a good green color indicating a healthy new growth.
   In May 2004, 1 tree was in good health but directly down slope form the trees in severe decline. Therefore, it was highly likely that the pathogen affecting the 2 trees will migrate into the roots of this healthy tree. In June 2005, this tree appeared to be in above average condition although shrouded by diseased trees.
   In May 2004, 1 tree was showing early signs of root rot (new terminal leaf growth was small and off green/yellow in color. The leaf flush was not adequate to cover the fruit and exposed fruit was not sizing and was becoming sunburned.) In June 2005, the decline of this tree appeared to have stopped and the Fall 2004 leaf flush was normal. A majority of the sunburned fruit present at the time of the treatment had been dropped. A majority of the unusually large fruit load was normally sized and shaped which is atypical of a tree stricken with pathogen Phytophthora cinnamomi avocado root rot. The spring flush was late but appeared vigorous (this could be as a result of the large fruit load that had not been picked yet). Old leaves remained on the tree and had a deep green color indicating active photosynthesis. (Trees under root rot stress typically drop their leaves before the new replacement flush starts.)
Young cv Hass avocado trees 3-years following planting in soil where diseased trees were recently removed and known to be contaminated with pathogen Phytophthora cinnanomi avocado root rot.
   In May 2004, 1 tree was in severe decline, showing small yellow leaves and no new terminal growth. In June 2005, this tree never recovered and was removed.
   In May 2004, 2 trees were showing below average growth but with normal leaf size and color. Terminal growth was later than normal and not as vigorous. In June 2005, these 2 trees recovered and were growing at a standard rate. The leaf size was standard to above average in size and color. Fall flush was normal, bloom was on time and large, and fruit was setting. These trees no longer showed signs of avocado root rot.
   In May 2004, 4 trees were showing below average growth but with normal leaf size and color. Terminal growth was later than normal and not as vigorous. In June 2005, these 4 trees recovered and were growing at an average to above average rate. The leaf size was standard to above average in size and color. Fall flush was normal, bloom was on time and large, and fruit was setting.

### Example 2

Diseased avocado trees have been treated in a farm in California which is located 4 miles Northwest of Valley Center California near the intersection of Lilac Vista and Berry roads. The disease was Phytophthora cinnamomi avocado root rot. The 96 tree test block was located within a 944-tree irrigation set 2, consisting mainly of 28-year old mature cv Hass avocado trees. This section of the grove has a history of significant pathogen Phytophthora cinnamomi avocado root rot.
2 trees were showing severe decline and had been marked for removal. These were injected in example one.
4 additional trees showed the early symptoms of root rot.
Because of the steep sloping terrain and the 2 sick trees showing severe decline being at the top of the slope all trees within this block have been and/or are subject to the spread of the pathogen Phytophthora cinnamomi avocado root rot.

Treatment was done in July 2004 as follows:

Application of the soil balancing nutrition minerals of potassium, calcium, nitrogen, manganese, iron and boron, Azomite was done at the rate of 1 lb per tree and MicroMate Humate at the rate of 1 lb per tree. The irrigation set was then adjusted to allow the application of the following additional soil remediation products.

IXPER® 75C Calcium Peroxide was applied through the irrigation micro sprinkler system at the rate of 4.6 lbs per tree. A slurry of water and Calcium Peroxide was mixed at a ratio of 20:1 and maintained under constant agitation. Then the slurry was injected into the irrigation system under standard irrigation flow rates and pressures. Following the Calcium Peroxide application the sprinklers ran for about 1 hr washing the material through the leaf litter to the root zone. The calcium peroxide appeared to be washed down or watered into the root zone of the plants.

Azomite rock powder was then applied through the irrigation micro sprinkler system at the rate of 4.5 lbs per tree. A slurry of water and Azomite powder was mixed at a ratio of 20:1 and maintained under constant agitation. Then the slurry was injected into the irrigation system under standard irrigation flow rates and pressures.

The biological treatment Spectrum Extra and Pepzyme M were combined with one of the mineral applications and applied to set 2. Spectrum Extra was applied at a rate of 75 gram per acre and Pepzyme M @ 25 oz per acre.

A year later, the 96 tree block has not shown noteworthy improvement but it is significant that it did not show further decline. Trees showing early symptoms of root rot have pushed a normal spring leaf-flush and color, bloom and fruit sets are normal to above average. It was an unusually wet winter that often leads to increased root rot damage. The spring temperatures have been below average with soil temperatures hovering in the 65 degree F. range. There does not seem to be excessive moisture levels in the root zones of the 96-tree block which in combination with cool temperatures supports the spread of root rot.

### Example 3

The above treatment regime was also applied to the soil before transplanting young trees. The soil did not seem to be contaminated with the avocado root rot but the plot was close to a contaminated site.

The trees are Hass avocado trees about 36 in tall and the trunk is 1.75 in on the average. The trees had an above average appearance when planted. 55 trees were treated and 64 trees were used as control. Treatment was as follows for each tree:
Azomite 1.25 cups/tree
Calcium Peroxide IXPER 75 granular 1 cup/tree
Mesa Verde Green Humates ¾ cup/tree
Spectrum Extra ¼ teaspoon/tree
Pepzyme ½ tablespoon/tree

Planting protocol was as follows
The soil for the treated trees was removed form a 12″ wide by 18″ deep planting hole and placed in a wheelbarrow.
The Azomite, Humate, Pepzyme, Spectrum & IXPER 75C Calcium Peroxide granules in the amounts prescribed above were then mixed into the planting-hole soil.
One shovel full of the soil/treatment mixed material was returned to the bottom of the planting hole.
The tree was removed from the Biogenesis 1 root dip, the plastic supporting the root ball was removed and the avocado tree placed in the hole.
The soil/treatment mixed material was placed in the hole around the root ball, filling the hole to about ½ the way to the top of the hole.
This material was compacted around the root ball prior to adding 2 gal of the root dip water to the hole.
The remaining material was then added filling the hole and compacted.
Following compaction 2 gal of the rood dip water was added to the final planting mound.
6 ft cedar planting/support poles were driven in next to the tree trunk and the tree was secured to the stake via plastic support tape.
Mulching wood chips were added in 18″ wide band (8-10 gal of wood chips) around the planted tree.
Mini-sprinkler irrigation head was placed about 12″ form the trunk.

Preliminary results after one year indicate that the treated trees show better growth on average than the trees that did not receive any treatment. 75% of the treated trees were graded as having above average growth vs. 70% in the control trees.

The above written description of the invention provides a method of using it such that any person skilled in the art is enabled to use the same, this enablement being provided in particular for the subject matter of the appended claims, which make up a part of the original description.

Where a numerical limit or range is stated, all values and subranges therewithin are specifically included as if explicitly written out.

The above description is presented to enable a person skilled in the art to make and use the invention, and is provided in the context of a particular application and its requirements. Various modifications to the preferred embodiments will be readily apparent to those skilled in the art, and the generic principles defined herein may be applied to other embodiments and applications without departing from the spirit and scope of the invention. Thus, this invention is not intended to be limited to the embodiments shown, but is to be accorded the widest scope consistent with the principles and features disclosed herein.

1-15. (canceled)

16: A method for controlling diseases caused by anaerobic agents in plants by at least partially preventing, stopping or reversing the damage caused by said anaerobic agents, comprising treating the plant or the soil in which the plant is growing or will grow with at least one inorganic peroxide.

17: A method according to claim 1, in which the plant or the soil is treated in addition with at least one additive chosen from biological agents, enzymes, humic acids, nutrients and mixtures thereof.

18: The method according to claim 16, in which the plants are chosen from crops, trees, ornamental plants and turfgrass.

19: The method according to claim 17, in which the plants are chosen from crops, trees, ornamental plants and turfgrass.

20: The method according to claim 16 in which the crops are chosen from potatoes, peppers, tomatoes, strawberries and raspberries, the trees are chosen from avocado, citrus and conifers, and the ornamental plants are Azaleas.

21: The method according to claim 16, in which said anaerobic agent causing the disease is a microbe, a fungus or a virus.

22: The method according to claim 16, in which the disease is root rot disease.

23: The method according to claim 16, in which said inorganic peroxide is chosen from magnesium peroxide, calcium peroxide, zinc peroxide, mixed calcium/magnesium peroxides, sodium percarbonate and mixtures thereof.

24: The method according to claim 16, in which said inorganic peroxide is used in the form of a powder, in the form of granules or in the form of an aqueous slurry.

25: The method according to claim 16, in which said inorganic peroxide and, optionally, at least one additive are applied to the soil before planting, or are applied to the soil by injecting a liquid in the form of an aqueous slurry of said inorganic peroxide and/or said additive near the plant.

26: The method according to claim 16, in which said inorganic peroxide and, optionally, at least one additive are spread on the surface of the soil, or are applied through an irrigation system.

27: The method according to any claim 16, in which the treatment with the inorganic peroxide and, optionally, at least one addition is repeated several times.

28: The method according to claim 17, in which said additive is added to the soil before, together with or after the inorganic peroxide.

29: The method according to claim 28, in which said inorganic peroxide is first applied and said additive is applied afterwards.

30: A formulation for the control of diseases caused by anaerobic agents in plants by at least partially preventing, stopping or reversing the damage caused by said anaerobic agents, comprising at least one inorganic peroxide and at least one additive chosen from biological agents, enzymes, humic acid, nutrients and mixtures thereof.

31: The formulation according to claim 30, in which said inorganic peroxide and said additive are not mixed so that they can be used separately.
